(19) United States
(12) Patent Application Publication
(10) Pub. No.: US 2008/0177520 A1
(43) Pub. Date: Jul. 24, 2008

(54) Characterising Biological Tissues

(76) Inventor: Michael Farquharson, London (GB)

Correspondence Address: ARENT FOX LLP, 1050 CONNECTICUT AVENUE, N.W., SUITE 400, WASHINGTON, DC, 20036, US

(21) Appl. No.: 11/587,255

(22) PCT Filed: Apr. 25, 2005
(86) PCT No.: PCT/GB2005/001573

§ 371 Date: Dec. 27, 2007

(30) Foreign Application Priority Data
Apr. 23, 2004 (GB) 0409127.8

(51) Int. Cl. G06G 7/48

(52) U.S. Cl. 703/11

(57) ABSTRACT

The invention describes a method for characterising and/or analysing body tissue, the method comprising: obtaining a first measured data set comprising data representing a first measured tissue property of a body tissue sample; obtaining a second measured data set comprising data representing a second measured tissue property of the body tissue sample; preprocessing at least the data representing the first measured tissue property to generate a first pre-processed data set; and using the first pre-processed data set along with the data representing the second measured tissue property (or data derived from it) in a multivariate model to provide an analysis and/or characterisation of the tissue sample. Additionally, the invention also describes a method for creating a model for characterising a tissue sample based on an analysis of a penetrating radiation (e.g. x-ray) diffraction profile measured from the tissue sample, as well as a method for characterising a tissue sample.

### FIELD OF THE INVENTION

The present invention relates to methods for the characterisation of biological tissue. More specifically, the invention is concerned with the characterisation of body tissue as normal (e.g. healthy) or abnormal (e.g. pathological). The invention has particular, although not necessarily exclusive, applicability to the diagnosis and management of cancer, including breast cancer.

### BACKGROUND

In order to manage suspected or overt breast cancer, tissue is removed from the patient in the form of a biopsy specimen and subjected to expert analysis by a histopathologist. This information leads to the disease management program for that patient. The analysis requires careful preparation of tissue samples that are then analysed by microscopy for prognostic parameters such as tumour size, type and grade. An important parameter in tissue classification is quantifying the constituent components present in the sample. Interpretation of the histology requires expertise that can only be learnt over many years based on a qualitative analysis of the tissue sample, which is a process prone to intra observer variability.

Despite the relative value of histopathological analysis, there remains a degree of imprecision in predicting tumour behaviour in the individual case. Additional techniques have the potential to fine-tune tissue characterisation to a greater degree than that currently used and hence will improve the targeted management of patients.

A number of different researchers have proposed the use of x-ray (or other penetrating radiation) diffraction profiles (referred to sometimes as “signatures”) to characterise tissue as normal or abnormal. The diffraction profile is the intensity of x-rays that are scattered (predominantly by diffraction effects) as a function of momentum transfer for a given tissue sample, and is characteristic of the tissue sample under investigation.

Examples include:
Poletti M. E., Goncalves O. D. and Mazzaro I 2002 X-ray scattering from human breast tissues and tissue equivalent materials. Phys. Med. Biol 47 375-82
Kidane G. Speller R. D., Royle G. J. and Hanby A. M. 1999 X-ray signatures form normal and neoplastic breast tissue Phys. Med. Biol 44 791-802

This approach has been shown to be successful to a degree. However, whilst it has proved possible to use this approach to distinguish adipose and malignant tissue (because there are large differences in the diffraction profiles for adipose and other tissue types), it has not been possible to discriminate tissue types at a finer level (e.g. to distinguish benign and malignant tumours).

Work carried out at the CCLRC Daresbury Laboratory in Cheshire, UK, results of which are published at http://detserv1.dl.ac.uk/Herald/xray_diff_results.htm, also suggest that x-ray diffraction profiles can provide useful information in the discrimination of tissue types. This work looks at ultra low angle x-ray scattering measurements and uses a conventional peak-fitting technique to analyse the measured data. Differences in the fitted peaks for normal and diseased tissue were observed and some explanations for the differences offered.

### SUMMARY OF THE INVENTION

In our co-pending UK patent application GB0328870.1 (GB '870), we describe a multivariate approach to characterising/analysing body tissue. In one general aspect, the present invention is concerned with improvements to that approach involving the pre-processing of measured data prior to its use for a varied assortment of biological tissue analysis and/or characterisation in a multivariate model (i.e. a model with two or more variable inputs).

In a first aspect, the invention provides a method for characterising and/or analysing biological tissue, the method comprising:
obtaining a first measured data set comprising data representing a first measured tissue property of a biological tissue sample;
obtaining a second measured data set comprising data representing a second measured tissue property of the biological tissue sample;
pre-processing at least the data representing the first measured tissue property to generate a first pre-processed data set; and
using the first pre-processed data set along with the data representing the second measured tissue property (or data derived from it) in a multivariate model to provide an analysis and/or characterisation of the tissue sample.

In preferred embodiments of this aspect of the invention, the data representing the second measured tissue property may also be pre-processed to generate a second pre-processed data set. The first and second pre-processed data sets can then be provided as inputs to the multivariate model (along with other inputs if desired).

In a preferred embodiment of the present invention the biological tissue sample comprises body tissue of human or animal origin. The body tissue samples may be obtained via surgical procedures or veterinary procedures. Alternatively, the biological tissue sample may be obtained from cell cultures or cell lines. These cell cultures or cell lines may have been grown or propagated or developed in Petri dishes or the like.

It is particularly preferred that data sets representing three, four or more measured biological tissue properties are used in the multivariate model. Each of these measured data sets may be pre-processed if desired or the multivariate model may have as inputs a combination of measured and pre-processed data sets.

Embodiments of this aspect of the invention may involve multiple pre-processing steps; a measured data set may be pre-processed to generate a pre-processed intermediate data set that then undergoes one or more further processing steps prior to use in the multivariate model.

In some embodiments, the pre-processing of one data set may involve use of one or more other data sets (measured or pre-processed). The pre-processed data set may, for example, result from a combination of two or more data sets. Alternatively, the steps involved in the pre-processing of a data set may be influenced by one or more other data sets without the data being combined.

The pre-processing steps would also be used when creating and training the multivariate model in the manner described in GB '870.

One preferred form of pre-processing where a measured data set is an x-ray (or other penetrating radiation) diffraction profile (or for other spectral-type data) is to apply a peak fitting algorithm to the profile data. The pre-processed data then comprises a series of fitted peaks; more specifically data defining the peaks. The data might define, for example, one or more of peak amplitude, peak centre value, peak area, FWHM (full-width half maximum—peak width), all of which are parameters that can be easily derived in a conventional manner using standard peak fitting algorithms.

Where this peak-fitting pre-processing approach is adopted, it is particularly preferred that the peaks that are fitted are pre-defined (i.e. the same peaks are fitted to each data set). This results in more consistency in the data input to the multivariate model, in particular consistency between data used to ‘train’ the model and subsequent data from samples to be characterised/analysed.

The pre-determined peaks may advantageously be those, for instance, that have been shown (e.g. empirically) to include the most information about the tissue characteristic(s) being considered. For example, where the aim is to distinguish normal and abnormal tissue, those peaks which have been shown to exhibit the greatest differences between these tissue types are preferably used.

This approach to analysing x-ray diffraction data by fitting a fixed, pre-determined set of peaks may also be useful in contexts other than pre-processing of data for use as an input to a multivariate model.

Accordingly, in another general aspect, the present invention is concerned with improved approaches to analysing x-ray diffraction profiles that offer advantages over the known techniques. A preferred aim of this aspect is to provide a technique for analysing x-ray diffraction data to differentiate between different types of abnormal and diseased tissue (e.g. to distinguish benign and malignant tumours).

In a second aspect the invention provides a method for creating a model for characterising a biological tissue sample based on an analysis of a penetrating radiation (e.g. x-ray) diffraction profile measured from the tissue sample, the method comprising:
obtaining diffraction profiles from a plurality of tissue samples having a known characteristic; and
for each diffraction profile, executing a peak fitting algorithm to deconvolve the profile into one or more discrete peaks; and
using the deconvolved profiles to provide a model relating known characteristic of the tissue samples to the peaks of the deconvolved profiles.

In a third aspect the invention provides a method for characterising a biological tissue sample, the method comprising:
obtaining a penetrating radiation (e.g. x-ray) diffraction profile measured from a tissue sample;
executing a peak fitting algorithm to deconvolve the diffraction profile into one or more discrete peaks; and
using the one or more peaks to characterise the tissue sample by comparison with a model obtained in accordance with the second aspect above.

It is preferred that models created in accordance with the second aspect are based on a fixed set of peaks (i.e. having fixed locations or centres). This fixed set of peaks is fitted to the measured data to deconvolve the profile, which is then used to generate the model. To characterise an unknown tissue sample, the diffraction profile can be deconvolved (in accordance with the third aspect) into the same, fixed set of peaks and a comparison of other peak parameters (e.g. amplitude, area, FWHM) used to compare the unknown sample with the model.

The peaks selected for the model are preferably those that have been shown (e.g. empirically) to include the most information about the tissue characteristic(s) being considered. For example, for body tissue where the aim is to distinguish benign and malignant tumours, those peaks that have been shown to exhibit the greatest differences between these tissue types are preferably used.

The fixed set of peaks is preferably determined based on analysis of very high quality data from multiple samples of each of the various tissue types it is intended the model will distinguish.

### BRIEF DESCRIPTION OF THE DRAWINGS

An embodiment of the invention is described below by way of example with reference to the accompanying drawings, in which:

FIG. 1 is a schematic of the experimental set-up that can be used to measure angular dispersive X-ray scatter profiles;

FIG. 2 shows X-ray scatter profiles for benign, malignant and adipose samples obtained using the apparatus of FIG. 1;

FIG. 3 is a schematic of the experimental set-up that can be used to measure energy dispersive X-ray scatter profile;

FIG. 4 is a diagram of the electronics used with the apparatus of FIG. 3;

FIG. 5 shows the X-ray tube spectrum for the tube in the apparatus of FIG. 3 at 70 kVₚ;

FIG. 6 shows two scatter spectra, one from a mostly adipose and the other from a mostly fibrous specimen;

FIG. 7 is a graph showing a comparison between average adipose and average tumour scatter spectra;

FIG. 8 shows schematically an alternative two collimator EDXRD system used;

FIG. 9 is a graph of average scatter profiles for three different tissue types; and

FIG. 10 shows a fixed set of peaks fitted to measured scatter profile data.

### DESCRIPTION OF EMBODIMENT

The invention is described below with reference to an exemplary embodiment using x-ray scatter profiles to characterise body tissue as malignant, benign or adipose.

### Data Collection—Angular Dispersive X-Ray Scatter Measurements

One method by which useful data can be obtained from tissue samples is through angular dispersive X-ray scatter measurements. In the example described here, experiments were performed using a synchrotron radiation facility, from which the desired high quality data can be obtained.

The experiments were performed at the European Synchrotron Radiation Facility (ESRF) at Grenoble, France. The beamline used was BM28, the XMaS beamline, which is a facility specifically designed for scattering experiments. The beam can be tuned up to an energy of 15 keV, with the ability to easily focus the beam to a very small size. A high flux allows for good counting statistics and short measurement times. The equipment available at ESRF made it possible to do extremely accurate measurements.

The beam is equipped with an 11-axis Huber diffractometer, which allows a detector to be mounted onto a mobile arm. This arm can then be translated and rotated. All rotation is accurately centred about a single point with accuracy of the order of microns. A sample holder holds the sample at the centre of rotation. An evacuated tube was fitted between the sample and the detector. This reduces background scatter and allows for very precise collimation close to the sample. The tube houses a set of four slit collimators along its length, two sets in the x-direction and two sets in the y direction. The detector used was a Bicron Nal scintillation detector.

Due to time restrictions the study looked at 5 samples of each tissue type, the benign tissues were fibroadenomas and the malignant were invasive ductal carcinomas.

The experiment was run at 13 keV. At this energy the flux is 10¹³ photons per second. The beam was focussed down to be 0.4 mm×0.4 mm at the sample surface. The tissue samples were held in a specially constructed holder at 50° from the incident beam axis. This was to ensure that the frame of the sample holder would not lie within the path of the scattered beam at any measurement angle. The samples were secured with 4 μm. thickness Mylar film, to ensure minimum beam attenuation. The radiation reaching the detector was collimated to 0.4 mm×0.4 mm at the detector surface using the evacuated slit collimators described above. A measurement of the number of scattered photons was made at 0.1° intervals over an angular range from 5.5 to 50° in the vertical plane.

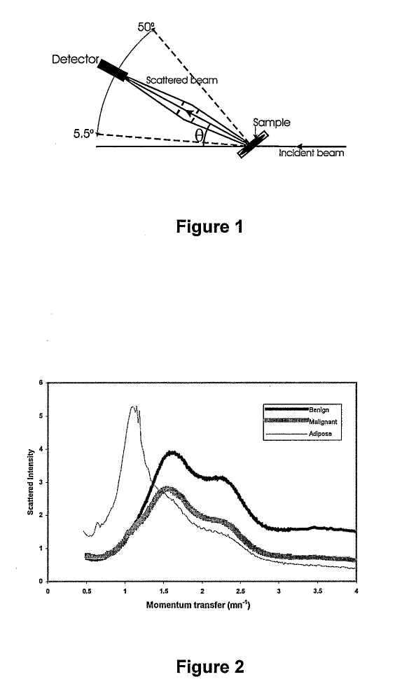

FIG. 1 illustrates the experimental set-up.

The results shown in FIG. 2 were obtained, where scatter intensity is plotted against momentum transfer. This is calculated as

$$x = \frac{E}{hc} sin ( \frac{θ}{2} )$$

The data has been corrected for attenuation within the sample and scattering volume. This was done because the tissue samples were not of identical geometry, so the data would not be comparable unless corrected for these effects.

Data Collection—Energy dispersive X-ray Scatter Measurements

Another method by which equivalent data can be obtained from tissue samples is energy dispersive X-ray diffraction (EDXRD) measurements.

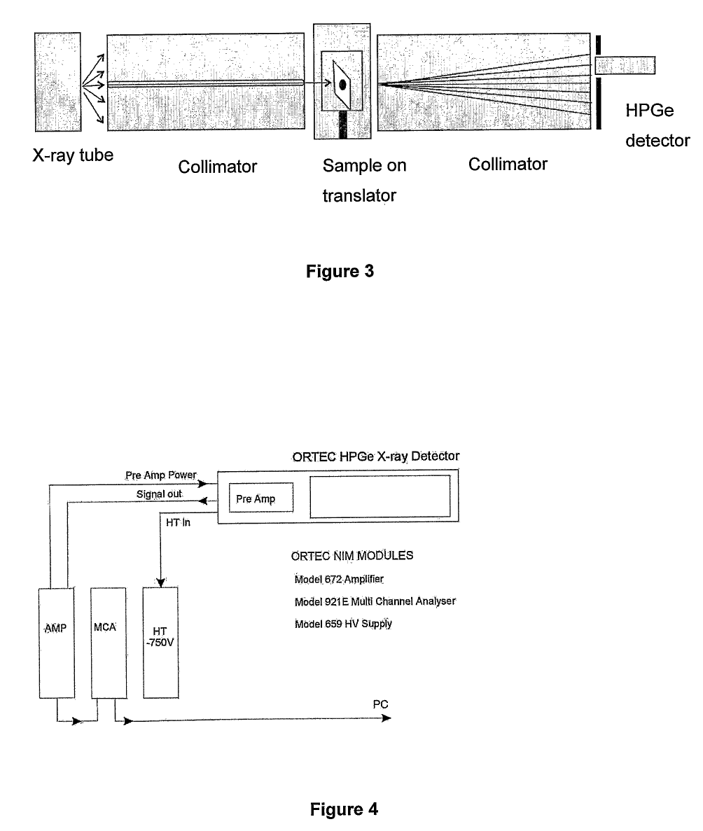

FIG. 3 illustrates an experimental set-up used to acquire the X-ray diffraction signatures (‘profiles’) from the constituent materials of the breast tissue specimens. The x-ray source was a tungsten anode x-ray tube (Comet) operated at 70 kVp and 8 mA. In order to achieve a well-collimated geometry defining the required scatter angle, two dural blocks were employed as collimators of the initial and the scattered photon beam. One block was used to collimate the beam originating from the x-ray tube incident on the sample; this was achieved by means of a channel cut in the block. The width of the channel was 1 mm while the height was adjusted to 2 mm, resulting in a beam size on the sample of 1 mm by 2 mm. The second block incorporated a number of similar channels set at various angles in order to allow investigation of a number of scatter angles.

The momentum transfer values where the coherent scatter signals from adipose and fibrous tissue are maximum were known from published data. These momentum transfer values, 1.1 nm¹ for adipose and 1.6 nm⁻¹ for fibrous, lead to the estimation of the appropriate scatter angle for the experiment after taking into consideration the x-ray spectrum provided by the x-ray tube.

An HPGe detector (EG&G Ortec) was used to collect the scattered photons and a 92× SpectrumMaster (EG&G) was used for the pulse height analysis and for displaying the spectra acquired as shown in FIG. 4

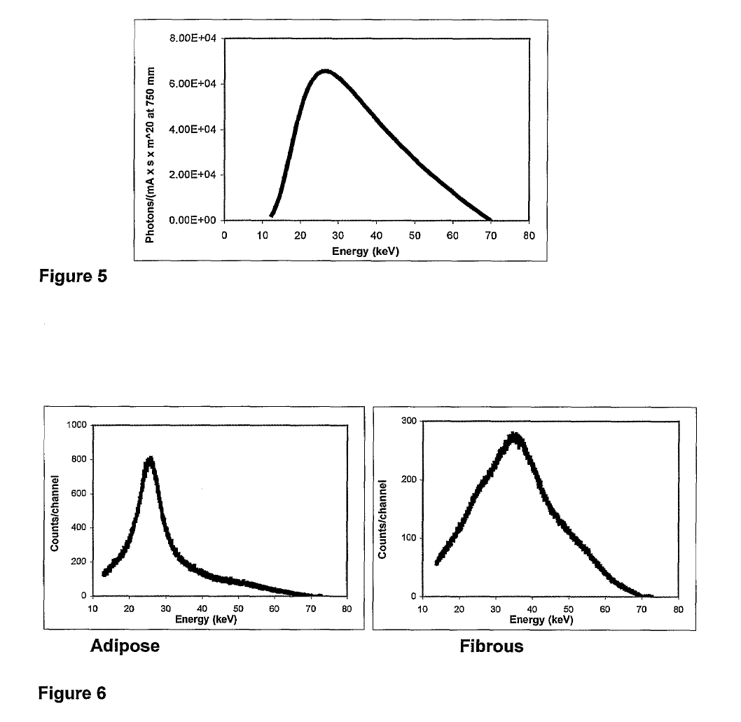

FIGS. 5 and 6 show the original x-ray tube spectrum and how this is modified when scattered by a specimen that is predominately adipose tissue (healthy sample) and by a specimen which is mostly fibrous (tumour).

The diffraction peak characteristic of adipose tissue appears at 26 keV in this case, equivalent to momentum transfer value of 1.1 nm⁻¹, while the one related to fibrous tissue appears at 36 keV, equivalent to momentum transfer value of 1.5 nm⁻¹. The momentum transfer values

$$x = \frac{E}{12.4} sin ( \frac{θ}{2} ) \qquad ( 1 )$$

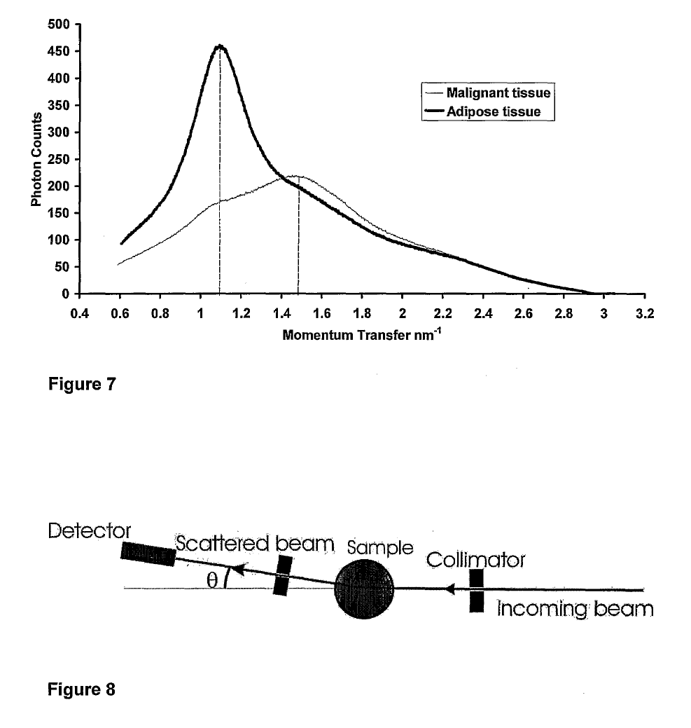

The two diffraction spectra of FIG. 7 are the spectra acquired from the healthy tissue specimens and the spectra acquired from the tumour samples. It is evident that the two types of specimens differ considerably in the relative amounts of adipose and fibrous tissue they contain.

FIG. 8 shows an alternative two collimator EDXRD system we have used.

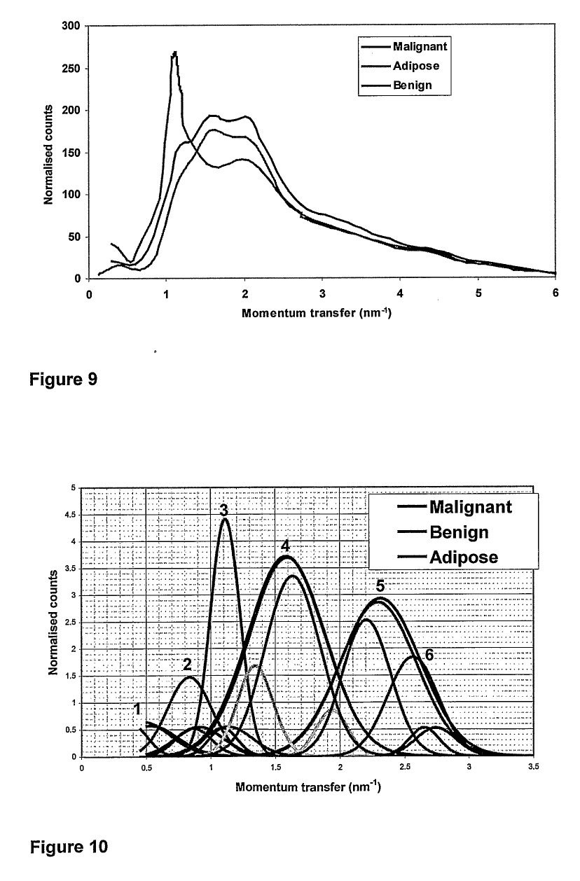

The samples are placed at the centre of a rotating platform, positioned so that the measurement volume was in the centre of the tissue. The samples were then rotated about their central axis and measurements repeated. This was to reduce any effects caused by tissue inhomogeneities through the measurement plane. The beam was collimated to 0.5 mm using a lead collimator both before and after the sample. The distances between the tube, sample and detector were kept to a minimum to reduce any loss flux due to inverse square The scatter profiles obtained are shown in the graph in FIG. 9.

### Data Analysis

Having obtained scatter profiles (by whichever technique) for the different tissue types, in accordance with a preferred embodiment of the present invention, a peak fitting routine is carried out on the data and a set of peaks chosen that can be used to characterise the tissue types. An example is shown in FIG. 10.

In this example 6 peaks were chosen for the model but other models with fewer or more peaks could be used. An example of the parameters used is in the table below.

| Peak | | Adipose | Benign | Malignant |
|---|---|---|---|---|
| 1 | Amplitude | 0.61 | 0.64 | 0.57 |
| | Centre | 0.384 | 0.473 | 0.532 |
| | FWHM | 0.29 | 0.51 | 0.50 |
| | Area | 0.14 | 0.19 | 0.17 |
| 2 | Amplitude | 1.47 | 0.52 | 0.55 |
| | Centre | 0.835 | 0.864 | 0.910 |
| | FWHM | 0.40 | 0.33 | 0.44 |
| | Area | 0.62 | 0.18 | 0.25 |
| 3 | Amplitude | 4.41 | 0.55 | 0.52 |
| | Centre | 1.112 | 1.129 | 1.092 |
| | FWHM | 0.27 | 0.45 | 0.26 |
| | Area | 1.25 | 0.26 | 0.14 |
| 4 | Amplitude | 3.35 | 3.69 | 3.71 |
| | Centre | 1.634 | 1.593 | 1.584 |
| | FWHM | 0.50 | 0.69 | 0.70 |
| | Area | 1.79 | 2.72 | 2.77 |
| 5 | Amplitude | 2.53 | 2.86 | 2.92 |
| | Centre | 2.204 | 2.295 | 2.313 |
| | FWHM | 0.44 | 0.69 | 0.72 |
| | Area | 1.19 | 2.11 | 2.24 |
| 6 | Amplitude | 1.84 | 0.52 | 0.52 |
| | Centre | 2.563 | 2.650 | 2.741 |
| | FWHM | 0.46 | 0.27 | 0.36 |
| | Area | 0.90 | 0.15 | 0.20 |

Given that this data is representative of a tissue category, the ratio of the peak heights can be used as a tissue discriminator.

### Model Generation

The peak data above can be used as a training set to produce a calibration model. It is preferably used in conjunction with other measured data (e.g. Compton scatter, XRF, etc) as training data for a multivariate model as described in our co-pending UK patent application GB '870.

Alternatively a model may be created using only the peak data, but this is less preferred.

### Tissue Sample Characterisation

Once the model has been generated, it can be used to predict whether an unknown tissue sample is adipose, benign or malignant.

To do this, X-ray scatter measurements are taken from the unknown tissue sample, the fixed set of peaks used to create the peak data on which the model is based is fitted to this data, and the peak data obtained by doing this is input to the model (along with other measured data from the sample—Compton scatter, etc—in the preferred case of a multivariate model.

An embodiment of the invention has been described above by way of example. It will be appreciated that various modifications to that which has been specifically described can be made without departing from the invention. For instance, the approach described can be applied to the determination of other tissue characteristics or other tissue analysis. The approach is also applicable to the analysis of ‘profile’ data other than X-ray scatter profiles.

1. A method for characterising and/or analysing biological tissue, the method comprising:
obtaining a first measured data set comprising data representing a first measured tissue property of a biological tissue sample;
obtaining a second measured data set comprising data representing a second measured tissue property of the biological tissue sample;
pre-processing at least the data representing the first measured tissue property to generate a first pre-processed data set; and
using the first pre-processed data set along with the data representing the second measured tissue property in a multivariate model to provide an analysis and/or characterisation of the tissue sample.

2. A method according to claim 1, wherein the data representing the second measured tissue property is also pre-processed to generate a second pre-processed data set.

3. A method according to claim 1, wherein the biological tissue is body tissue of human origin.

4. A method according to claim 1, wherein the biological tissue is body tissue of animal origin.

5. A method according to claim 1, wherein data sets representing at least three measured tissue properties are used in the multivariate model.

6. A method according to claim 1, wherein all of said measured data sets are pre-processed.

7. A method according to claim 1, wherein the multivariate model has a combination of measured and pre-processed data sets as inputs.

8. A method according to claim 1, wherein the method comprises multiple pre-processing steps.

9. A method according to claim 8, wherein a measured data set is pre-processed to generate a pre-processed intermediate data set that then undergoes one or more further processing steps prior to use in the multivariate model.

10. A method according to claim 1, wherein the pre-processing of one data set comprises use of one or more other data sets.

11. A method according to claim 1, wherein the pre-processing of one data set comprises the application of a peak fitting algorithm to the profile data.

12. A method according to claim 11, wherein the pre-processed data defines at least one of: peak amplitude; peak centre value; peak area; FWHM.

13. A method according to claim 11, wherein the fitted peaks of the peak-fitting pre-processing approach are pre-defined.

14. A method for creating a model for characterising a biological tissue sample based on an analysis of a penetrating radiation diffraction profile measured from the tissue sample, the method comprising:
obtaining diffraction profiles from a plurality of tissue samples having a known characteristic; and for each diffraction profile, executing a peak fitting algorithm to deconvolve the profile into one or more discrete peaks; and
using the deconvolved profiles to provide a model relating said known characteristic of the tissue samples to the peaks of the deconvolved profiles.

15. A method for characterising a biological tissue sample, the method comprising:
obtaining a penetrating radiation diffraction profile measured from a tissue sample;
executing a peak fitting algorithm to deconvolve the diffraction profile into one or more discrete peaks; and
using the one or more peaks to characterise the tissue sample by comparison with a model obtained in accordance with the second aspect above.

16. A method according to claim 14, wherein the biological tissue is body tissue of human origin.

17. A method according to claim 14, wherein the biological tissue is body tissue of animal origin.

18. A method according to claim 14, wherein said model is based on a fixed set of peaks.

19. A method according to claim 18, wherein the fixed set of peaks is fitted to the measured data to deconvolve the profile, which is then used to generate the model.

20. A method according to claim 15, wherein the diffraction profile is deconvolved into a fixed set of peaks and a comparison of other peak parameters is used to compare the unknown sample with the model.

21. A method according to any of claims 1, wherein the method is used to distinguish between benign and malignant tumours.
